(19) United States
(12) Patent Application Publication
(10) Pub. No.: US 2026/0079371 A1
(43) Pub. Date: Mar. 19, 2026

(54) DISPLAY DEVICE

(71) Applicant: Japan Display Inc., Tokyo (JP)

(72) Inventor: Gen KOIDE, Tokyo (JP)

(21) Appl. No.: 19/331,202

(22) Filed: Sep. 17, 2025

(30) Foreign Application Priority Data
Sep. 18, 2024 (JP) 2024-161018

(51) Int. Cl. G02F 1/1362; F21V 8/00; G02F 1/1334; G02F 1/1368

(52) U.S. Cl. CPC G02F 1/136286; G02B 6/0068; G02F 1/1334; G02F 1/1368

(57) ABSTRACT

According to one embodiment, a display device includes a display panel including a display area, and a plurality of light-emitting units, and the display panel includes scanning lines and signal lines intersecting the scanning lines, and the plurality of light-emitting units are arranged along a first edge extending in a first direction of the display panel in plan view, and each of the scanning lines and signal lines extends in a direction different from the first direction and a second direction perpendicular to the first direction in the display area in plan view.

### CROSS-REFERENCE TO RELATED APPLICATIONS

This application is based upon and claims the benefit of priority from Japanese Patent Application No. 2024-161018, filed Sep. 18, 2024, the entire contents of which are incorporated herein by reference.

### FIELD

Embodiments described herein relate generally to a display device.

### BACKGROUND

Various display devices using polymer-dispersed liquid crystals that can switch between a scattering state that scatters incident light and a transparent state that transmits incident light have been proposed. In some display devices using polymer-dispersed liquid crystals, the edge-light method, in which a light emitting module is arranged at an edge of the display panel, is used.

Part of the illumination light emitted from the light emitting module may be reflected by wiring lines provided perpendicular to the progressing direction of the light. If such undesired reflected light leaks outside the display panel near the wiring line, deterioration in display quality may result. On the other hand, if a wide light-shielding layer is provided directly above the wiring lines to suppress such leakage of reflection light, reduction of the aperture area of the pixels may result. Under these circumstances, a technique of forming the wiring lines into a curved shape has been proposed.

### BRIEF DESCRIPTION OF THE DRAWINGS

FIG. 1 is a diagram showing a configuration example of a display device according to one embodiment.

FIG. 2 is a cross-sectional view schematically showing the configuration example of the display device according to the embodiment.

FIG. 3 is a diagram illustrating the relationship between irradiated light and scanning lines and signal lines.

FIG. 4 is a cross-sectional view of the display device DSP taken along the line A-B shown in FIG. 3.

FIG. 5 is a diagram showing a configuration example of the scanning lines and signal lines.

FIG. 6 is a diagram showing another configuration example of the display device DSP.

FIG. 7 is a diagram showing still another configuration example of the display device DSP.

### DETAILED DESCRIPTION

In general, according to one embodiment, a display device comprises a display panel including a display area which displays images, and a plurality of light-emitting units each having a light-emitting surface which irradiates light toward the display panel, and the display panel includes a first transparent substrate, a second transparent substrate facing the first transparent substrate, a liquid crystal layer containing a polymer-dispersed liquid crystal and located between the first transparent substrate and the second transparent substrate, scanning lines located between the first transparent substrate and the liquid crystal layer, and signal lines located between the first transparent substrate and the liquid crystal layer and intersecting the scanning lines, and the plurality of light-emitting units are arranged along a first edge extending in a first direction of the display panel in plan view, and each of the scanning lines and signal lines extends in a direction different from the first direction and a second direction perpendicular to the first direction in the display area in plan view.

According to another embodiment, a display device comprises a display panel comprising polymer-dispersed liquid crystal, and a plurality of light-emitting units arranged along a first direction, and the display panel comprises a first non-display area, a display area, and a second non-display area arranged in order along the first direction, a plurality of scanning lines arranged along the first direction in the display area, and a plurality of signal lines arranged along the first direction in the display area and intersecting the plurality of scanning lines, and an outermost scanning line of the plurality of scanning lines is located in either one of the first non-display area and the second non-display area, and extends in a direction different from the first direction and a second direction, which is perpendicular to the first direction, in the display area, and an outermost signal line of the plurality of signal lines is located in an other one of the first non-display area and the second non-display area and extends in a direction different from the first direction and the second direction in the display area.

According to the configurations described above, it is possible to provide a display device that can improve display quality.

Embodiments will be described hereinafter with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc. of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Note that the drawings include X, Y, and Z axes that are mutually perpendicular to each other as necessary to facilitate understanding. The direction along the X axis is referred to as a first direction X, the direction along the Y axis is referred to as a second direction Y, and the direction along the Z axis is referred to as a third direction Z. Viewing various elements parallel to the third direction Z is referred to as a plan view. Further, note that terms indicating the relative positions of two or more components, such as “above”, “upward”, “between”, and “opposing”, include not only cases where the two or more components are in direct contact but also cases where they are separated by gaps or other components interposed therebetween.

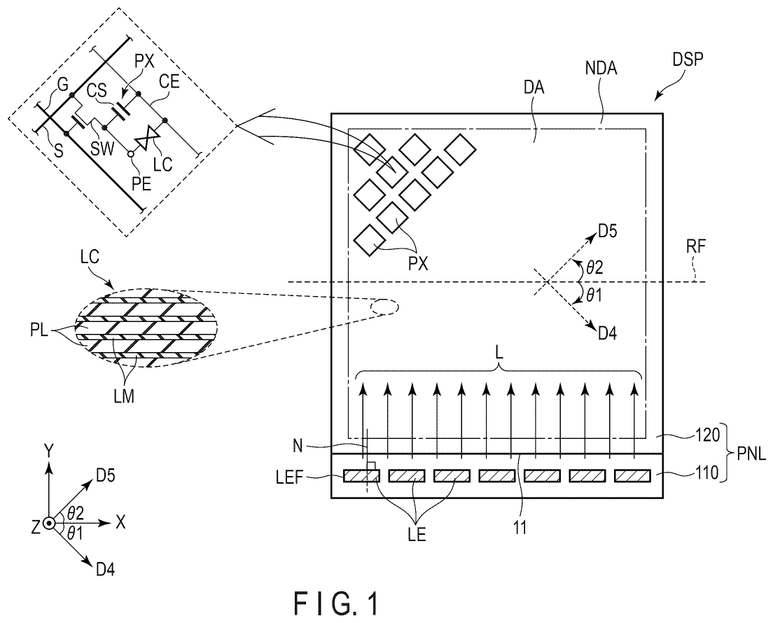

FIG. 1 is a diagram showing a configuration example of a display device DSP according to one embodiment.

The display device DSP includes a display panel PNL configured to display images and a plurality of light-emitting units LE that irradiate light L toward the display panel PNL.

The display panel PNL includes a transparent substrate 110 and a transparent substrate 120. Each of the transparent substrate 110 and transparent substrate 120 is formed into a flat plate parallel to the X-Y plane defined by the first direction X and the second direction Y. The transparent substrates 110 and 120 overlap each other in plan view. The transparent substrate 110 extends further in the second direction Y than the transparent substrate 120. In the example illustrated, the transparent substrate 110 and transparent substrate 120 are both formed as rectangles, but the shape is not limited to that mentioned here. For example, the transparent substrate 110 and transparent substrate 120 may have any shape, such as a polygon other than a rectangle, a circle, an ellipse, or a semicircle.

The display panel PNL further includes a liquid crystal layer LC sealed between the transparent substrate 110 and the transparent substrate 120. The liquid crystal layer LC is placed on an image display area DA and a non-display area NDA located on an outer side of the image display area DA. As shown in FIG. 1 in enlarged view, the liquid crystal layer LC is constituted by polymer dispersed liquid crystal containing polymers PL and liquid crystal molecules LM.

In one example, the polymers PL are liquid crystal polymers. The polymers PL are formed into a strip-like shape extending along the first direction X and arranged along the second direction Y in plan view. The liquid crystal molecules LM are dispersed in the gaps between the polymers PL and arranged such that their longitudinal axes align with the first direction X.

Both the polymer PL and the liquid crystal molecules LM exhibit optical anisotropy or refractive index anisotropy. The response of the polymers PL to an electric field is lower than the response of the liquid crystal molecules LM to the electric field.

In one example, the alignment direction of the polymers PL remains substantially unchanged regardless of the presence or absence of an electric field. In contrast, the alignment direction of the liquid crystal molecules LM changes according to the voltage applied to the liquid crystal layer LC.

When no voltage is being applied to the liquid crystal layer LC, the optical axes of the polymers PL and the liquid crystal molecules LM are parallel to each other, and light entering the liquid crystal layer LC passes through the liquid crystal layer LC without being substantially scattered (transparent state).

When a voltage is being applied to the liquid crystal layer LC, the optical axes of the polymers PL and the liquid crystal molecules LM intersect with each other, and light entering the liquid crystal layer LC is scattered within the liquid crystal layer LC (scattering state).

Note that the composition of the polymer-dispersed liquid crystal containing the polymers PL and the liquid crystal molecules LM is not limited to that of the example set out above.

In this embodiment, the direction different from the first direction X and the second direction Y in plan view is defined as a fourth direction D4. Further, the direction different from the first direction X, the second direction Y, and the fourth direction D4 in plan view is defined as a fifth direction D5.

The fourth direction D4 is a direction which forms a first angle θ1 with respect to a reference line RF, which is parallel to the first direction X. The first angle θ1 is an acute angle that is clockwise relative to the reference line RF. The fifth direction D5 is a direction which forms a second angle θ2 with respect to the reference line RF. The second angle θ2 is an acute angle that is counterclockwise relative to the reference line RF. Each of the first angle θ1 and the second angle θ2 should preferably be, for example, 30 degrees or more and 45 degrees or less. In one example, the first angle θ1 is equal to the second angle θ2.

The display area DA, in plan view, comprises a plurality of pixels PX arranged in a matrix along the fourth direction D4 and the fifth direction D5.

As shown enlarged in the figure, each of the pixels PX comprises a switching element SW, a pixel electrode PE, a common electrode CE, a liquid crystal layer LC, and the like. The switching element SW is constituted, for example, by a thin film transistor (TFT), and electrically connected to a respective one of scanning lines G and a respective one of signal lines S.

The scanning lines G extend in a direction different from the first direction X and the second direction Y in the display area DA, that is, for example, in the fourth direction D4. The scanning lines G are electrically connected respectively to the switching elements SW of multiple pixels PX arranged along the fourth direction D4.

The signal lines S intersect the scanning lines G in the display area DA and extend in a direction different from the first direction X and the second direction Y, that is, for example, in the fifth direction D5. The signal lines S are electrically connected respectively to the switching elements SW of multiple pixels PX arranged along the fifth direction D5.

The pixel electrodes PE are electrically connected to the switching elements SW, respectively. Each of the pixel electrodes PE faces the common electrode CE, and the liquid crystal layer LC (in particular, the liquid crystal molecules LM) is driven by the electric field generated between the pixel electrodes PE and the common electrode CE. For example, between, an electrode having the same potential as that of the common electrode CE and an electrode having the same potential as that of a pixel electrode PE, a capacitance CS is formed.

The scanning lines G, signal lines S, switching elements SW, and pixel electrodes PE are formed between the transparent substrate 110 and the liquid crystal layer LC. The common electrode CE is formed between the transparent substrate 120 and the liquid crystal layer LC.

Light-emitting units LE are configured to irradiate light L toward the display panel PNL. A plurality of light-emitting units LE are arranged along a first edge 11 of the display panel PNL. In the example illustrated, the first edge 11 extends in the first direction X.

The light L is emitted from a light-emitting surface LEF of each of the light-emitting units LE. For example, the normal N of the light-emitting surface LEF is parallel to the second direction Y. In this case, the light L emitted from the light-emitting surface LEF propagates along the second direction Y within the display panel PNL.

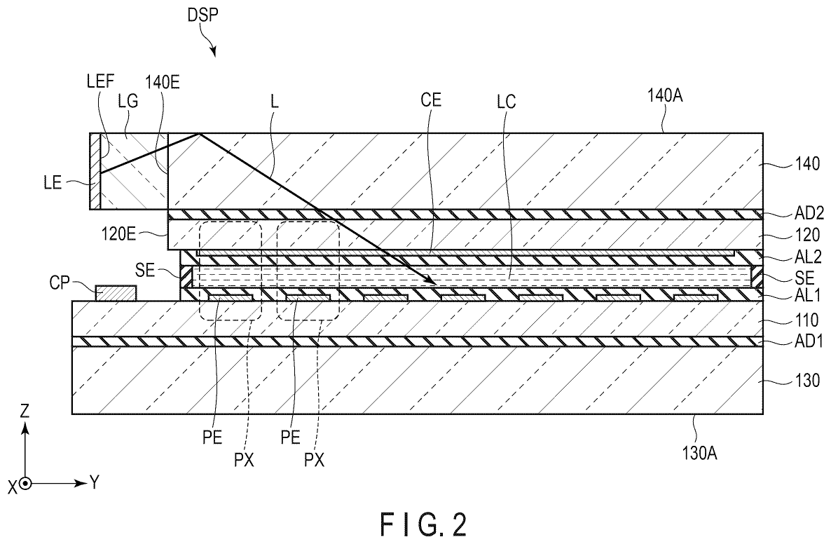

FIG. 2 is a cross-sectional view schematically showing the display device according to the embodiment.

Note that FIG. 2 schematically shows the configuration of the display panel PNL and the like, and elements such as the scanning lines G, signal lines S, and switching elements SW are omitted from the illustration.

The transparent substrate 110 and transparent substrate 120 face each other along the third direction Z. The liquid crystal layer LC is located between the transparent substrate 110 and the transparent substrate 120. The pixel electrode PE of the pixels PX is located between the transparent substrate 110 and the liquid crystal layer LC and is covered by an alignment film AL1. The common electrode CE, which faces multiple pixel electrodes PE, is located between the transparent substrate 120 and the liquid crystal layer LC and is covered by an alignment film AL2. The liquid crystal layer LC is in contact with the alignment film AL1 and alignment film AL2. The pixel electrodes PE and the common electrode CE are transparent electrodes formed from a transparent conductive material such as indium tin oxide (ITO). The IC chip CP and the flexible printed circuit board (not shown) are mounted on the transparent substrate 110.

In the example illustrated, the display panel PNL further comprises a transparent substrate 130, a transparent substrate 140, and a light guide LG. The transparent substrate 130 is adhered to the transparent substrate 110 via a transparent adhesive layer AD1. The transparent substrate 140 is adhered to the transparent substrate 120 via a transparent adhesive layer AD2. The light guide LG is located between the light-emitting unit LE and the transparent substrate 140 along the second direction Y.

A side surface 120E of the transparent substrate 120 and a side surface 140E of the transparent substrate 140 overlap each other along the third direction Z. In this case, the side surface 120E and the side surface 140E correspond to the first edge 11 of the display panel PNL shown in FIG. 1.

Note that the transparent substrate 140 may extend along the second direction Y beyond the transparent substrate 120. When the side surface 120E of the transparent substrate 120 is located between the side surface 140E of the transparent substrate 140 and the display area DA along the second direction Y, the side surface 140E corresponds to the first edge 11 of the display panel PNL shown in FIG. 1.

In the example illustrated, a main surface 130A of the transparent substrate 130 and a main surface 140A of the transparent substrate 140 are both parallel to the X-Y plane and brought into contact with air.

The adhesive layer AD1 and adhesive layer AD2 have a refractive index equal to that of the transparent substrate 110, the transparent substrate 120, the transparent substrate 130, and the transparent substrate 140. With this configuration, undesired interface reflection is suppressed between the transparent substrate 110 and the transparent substrate 130, and between the transparent substrate 120 and the transparent substrate 140.

The light-emitting units LE each face the side surface 140E of the respective transparent substrate 140 along the second direction Y. Note that the light-emitting units LE may each be placed to face both the side surface 120E and the side surface 140E. The light-emitting units LE, though will not be described in detail, include red light-emitting units, green light-emitting units, and blue light-emitting units. These red light-emitting units, green light-emitting units, and blue light-emitting units may be lit sequentially or all simultaneously.

The transparent substrates 110, 120, 130, and 140 are, for example, glass substrates, but may as well be resin substrates. The transparent substrates 130 and 140 function as cover members. Further, the transparent substrate 140 functions as a light guide that propagates the light L emitted from the light-emitting units LE along the second direction Y.

In one example, the transparent substrate 130 is thicker than the transparent substrate 110, and the transparent substrate 140 is thicker than the transparent substrate 120. Note that at least one of the transparent substrate 130 and transparent substrate 140 may be omitted. When the transparent substrate 140 is omitted, the light-emitting units LE are arranged so as to face the side surface 120E of the transparent substrate 120 in the second direction Y.

In the display panel PNL with such a configuration, when a voltage is applied to each pixel PX, the light L emitted from the light-emitting unit LE is scattered by the liquid crystal layer LC of each pixel PX, and becomes display light. Thus, an image is displayed in the display area DA. The display light emitted from the display panel PNL is linearly polarized light parallel to the first direction X.

When the liquid crystal layer LC is in a transparent state, external light entering the display panel PNL is transmitted through the liquid crystal layer LC without being substantially scattered. That is, external light entering the display panel PNL from the main surface 130A passes through the main surface 140A, and external light entering the display panel PNL from the main surface 140A passes through the main surface 130A. With this configuration, when the display panel PNL is observed from the side of the main surface 130A, the background can be observed through the display panel PNL. Similarly, when the display panel PNL is observed from the side of the main surface 140A, the background can be observed through the display panel PNL.

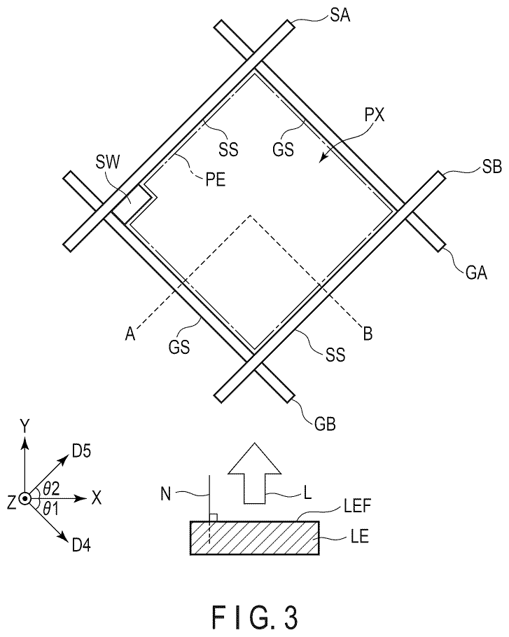

FIG. 3 is a diagram illustrating the relationship between the irradiated light and the scanning lines and signal lines.

In FIG. 3, an adjacent pair of scanning lines G are shown as a scanning line GA and a scanning line GB. Further, an adjacent pair of signal lines S that intersect the scanning line GA and scanning line GB are shown as a signal line SA and a signal line SB.

In the example illustrated, the normal N of the light-emitting surface LEF of the light-emitting unit LE is parallel to the second direction Y, and therefore the light L emitted from the light-emitting unit LE propagates along the second direction Y within the display panel PNL.

Each of the scanning line GA and scanning line GB extends in the fourth direction D4, which intersects the second direction Y in which the light L propagates, in plan view, and has a side surface GS extending in the fourth direction D4 on the side of the light-emitting unit LE. Each of the scanning line GA and scanning line GB extends in a linear manner and does not include any curved portions between the signal line SA and signal line SB.

Each of the signal lines SA and SB extends in the fifth direction D5, which intersects the second direction Y of the propagation of the light L, in plan view, and has a side surface SS extending in the fifth direction D5 on the side of the light-emitting unit LE. Each of the signal line SA and signal line SB extends in a linear manner and does not include any curved portions between the scanning line GA and scanning line GB.

As will be described later, the extending directions of the scanning lines G and signal lines S are not limited to those of this example, and the scanning lines G may extend in the fifth direction D5 and the signal lines S may extend in the fourth direction D4. Further, depending on the extending directions of the scanning lines G and signal lines S, the relative positions of the gate driver GD and source driver SD to which they are connected may vary.

Each of the pixels PX includes a switching element SW and a pixel electrode PE. In the example illustrated, the switching element SW is electrically connected to the respective scanning line GB and the respective signal line SA. The switching element SW is closer to the signal line SA than to the signal line SB in the fourth direction D4, and closer to the scanning line GB than to the scanning line GA in the fifth direction D5.

The pixel electrode PE is located between the signal line SA and the signal line SB and also between the scanning line GA and the scanning line GB. In the example illustrated, the pixel electrodes PE are each formed into a shape substantially the same as the region surrounded by the signal line SA, the signal line SB, the scanning line GA, and the scanning line GB, except for the vicinity of the switching element SW. Note that the position and shape of the pixel electrode PE are not limited to those of this example. For example, the pixel electrode PE may overlap the scanning lines G and signal lines S, and may have a roughly rectangular shape having sides parallel to the first direction X and the second direction Y.

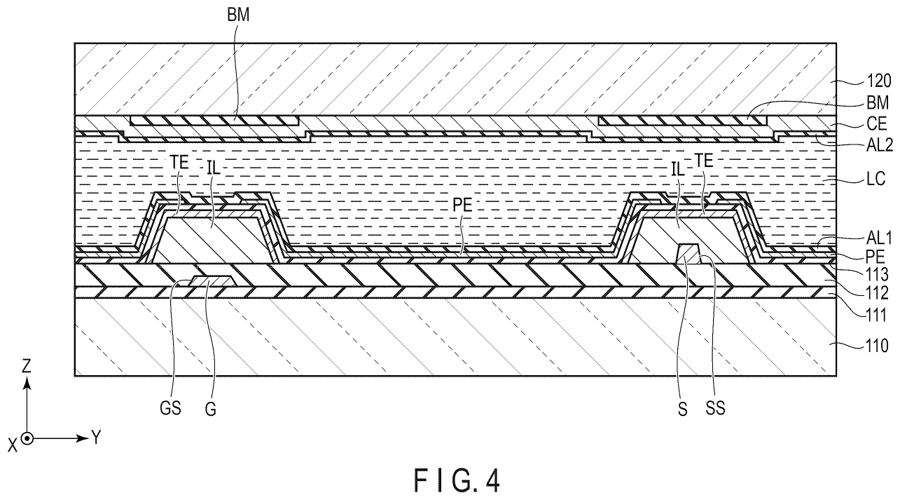

FIG. 4 is a cross-sectional view of the display device DSP taken along the line A-B shown in FIG. 3.

The insulating layer 111 is disposed on the transparent substrate 110. The insulating layer 112 is disposed on the insulating layer 111. The insulating layer 111 and insulating layer 112 are inorganic insulating layers formed, for example, of silicon oxide, silicon nitride, or silicon nitride oxide. The insulating layer IL is disposed on the insulating layer 112. The insulating layer IL is an organic insulating layer. The transparent electrode TE covers the insulating layer IL. The insulating layer 113 is disposed on the insulating layer 112 so as to cover the transparent electrode TE. The pixel electrode PE is disposed on the insulating layer 113. The insulating layer 113 is interposed between the transparent electrode TE and the pixel electrode PE. The alignment film AL1 covers the pixel electrode PE and the insulating layer 113 and is in contact with the liquid crystal layer LC.

The scanning line G is disposed on the insulating layer 111 and covered by the insulating layer 112. The scanning line G is, for example, a stacked layer body constituted by an aluminum layer formed from an aluminum-based material and a titanium layer formed from a titanium-based material.

The signal line S is disposed on the insulating layer 112 and covered by the insulating layer IL. The signal line S is, for example, a stacked layer body constituted by a titanium layer and an aluminum layer.

Note that the materials for forming the scanning lines G and the signal lines S are not limited to those of the examples set out above. For example, the signal line S may include a molybdenum layer formed from a molybdenum-based material.

The light-shielding layer BM is disposed between the transparent substrate 120 and the liquid crystal layer LC. Further, the light-shielding layer BM is located directly above the scanning line G and signal line S. Although not shown in the illustration, the light-shielding layer BM is located directly above the switching element SW as well.

The common electrode CE faces the pixel electrode PE in the third direction Z and covers the light-shielding layer BM. The alignment film AL2 covers the common electrode CE and is in contact with the liquid crystal layer LC.

According the display device DSP having such a configuration, as compared to the case where the scanning lines G or signal lines S are perpendicular to the light propagation direction, the component of light reflected outward from the display panel PNL at the side surfaces GS of the scanning lines G and the side surfaces SS of the signal lines S is reduced. With this configuration, light leakage caused by undesired reflection at the scanning lines G or signal lines S is suppressed, thereby making it possible to improve the display quality.

Moreover, there is no need to form a wide light-shielding layer to block undesired reflected light. As a result, a decrease in the aperture area of the pixels is suppressed.

Furthermore, there is no need to form the wiring lines into a curved shape to suppress undesired reflected light. As a result, an undesired increase in the resistance or capacitance of the wiring lines is suppressed.

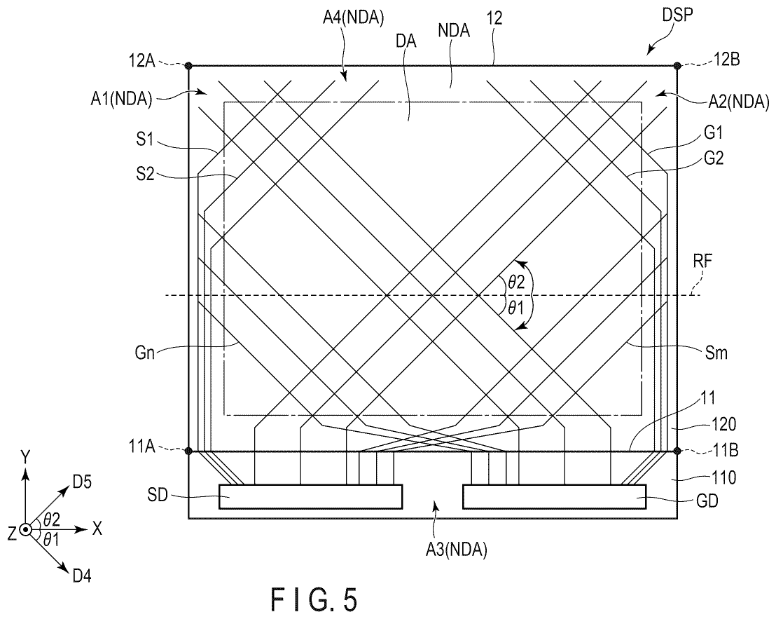

FIG. 5 is a diagram showing a configuration example of the scanning lines and signal lines.

In FIG. 5, the scanning lines G of the display panel PNL according to this embodiment are represented as scanning lines G1 to Gn, and the scanning line located at the outermost periphery of the display panel PNL is designated as an outermost scanning line G1. Similarly, the signal lines S are represented as signal lines S1 to Sm, and the signal line located at the outermost periphery of the display panel PNL is designated as an outermost signal line S1. Note that letters n and m each represent a natural number of 2 or larger. The values of n and m may be different or the same. Further, the positions and numbers of the scanning lines G1 to Gn and the signal lines S1 to Sm are not limited to those of the example shown in the figure.

The display panel PNL includes a display area DA which is an area displaying images and a non-display area NDA provided around the display area DA. For example, the display area DA is a rectangle shown by an alternate long and short dash line in FIG. 5, but the shape is not limited to that of this example.

In this embodiment, the non-display area NDA is an area on an outer side of the display area DA. For example, the non-display area NDA is an area defined by the alternate long and short dash line indicating the display area DA and the frame lines respectively indicating the edges of the transparent substrates 110 and 120 in plan view.

The non-display area NDA includes a first area A1 and a second area A2 located on respective sides of the display area DA along the first direction X, and a third area A3 and a fourth area A4 located on respective sides of the display area DA along the second direction Y. That is, the first area A1, the display area DA, and the second area A2 are arranged in this order along the first direction X, and the third area A3, the display area DA, and the fourth area A4 are arranged in this order along the second direction Y.

In one example, the first area A1 and the second area A2 are areas elongated along the second direction Y. The third area A3 and the fourth area A4 are areas elongated along the first direction X. Note that the boundaries of the first area A1 to the fourth area A4 are not strictly defined and one area may overlap with another area.

The display panel PNL, in plan view, has a first edge 11 extending along the first direction X and a second edge 12 facing the first edge 11 in the second direction Y and extending along the first direction X. The first edge 11 is located in the third area A3, and the second edge 12 is located in the fourth area A4. That is, between the first edge 11 and the second edge 12, the display area DA is located. Here, the first edge 11 and the second edge 12 are both edges of the transparent substrate 120.

The first edge 11 has a first end portion 11A and a second end portion 11B located on an opposite side to the first end portion 11A along the first direction X. The second edge 12 has a third end portion 12A and a fourth end portion 12B located on an opposite side to the third end portion 12A along the first direction X.

The first end portion 11A and the third end portion 12A face each other along the second direction Y. Further, the second end portion 11B and the fourth end portion 12B face each other along the second direction Y. In the example illustrated, the first end portion 11A to the fourth end portion 12B correspond to corner portions of the transparent substrate 120 in plan view. The first end portion 11A and the fourth end portion 12B are located diagonally opposite to each other. Further, the second end portion 11B and the third end portion 12A are located diagonally opposite to each other.

The display device DSP further comprises a gate driver GD configured to drive the scanning lines G1 to Gn, and a source driver SD configured to drive the signal lines S1 to Sm.

The outermost scanning line G1 is the closest to the second end portion 11B and the fourth end portion 12B among the scanning lines G1 to Gn. The outermost signal line S1 is the closest to the first end portion 11A and the third end portion 12A among the signal lines S1 to Sm.

The gate driver GD and source driver SD are provided on the transparent substrate 110 and are arranged along the first direction X in the non-display area NDA. The gate driver GD and source driver SD are controlled, for example, via an external wiring board.

In the example illustrated, the gate driver GD is arranged on the side of the second end portion 11B of the third area A3. The source driver SD is located on the side of the first end portion 11A of the third area A3. There may be multiple numbers of gate drivers GD and source drivers SD provided.

In the display area DA, each of the scanning lines G1 to Gn extends along the fourth direction D4. That is, the extending direction of each of the scanning lines G1 to Gn is in a direction that makes a first angle θ1 with respect to the reference line RF. In other words, each of the scanning lines G1 to Gn extends from the second end portion 11B toward the third end portion 12A. Note that the expression “extending from the second end portion 11B toward the third end portion 12A” is not necessarily limited to the case where each of the scanning lines G1 to Gn extends in a direction parallel to the straight line connecting the second end portion 11B and the third end portion 12A. In one example, these scanning lines G1 to Gn are parallel to each other in the display area DA.

Each of the scanning lines G1 to Gn is drawn out from the display area DA to the non-display area NDA and then connected to the gate driver GD. For example, some of these scanning lines G1 to Gn, including the outermost scanning line G1, are drawn out to the second area A2, then pass through the second area A2 and the third area A3, and are connected to the gate driver GD. In this case, the outermost scanning line G1 has a portion extending in the fourth direction D4, a portion extending in the second direction Y, and a portion extending toward the gate driver GD in the non-display area NDA, but the configuration is not limited to that of this example. For example, the outermost scanning line G1 may be constituted solely by the portion extending in the fourth direction D4 without having the portion extending in the second direction Y. Of the scanning lines G1 to Gn, the other scanning lines including the scanning line Gn are drawn out to the third area A3 without being drawn out to the second area A2 and are connected to the gate driver GD. With this configuration, compared to the case where all the scanning lines G1 to Gn are drawn out to the second area A2, the area of the second area A2 can be reduced, thereby making it possible to achieve narrow bezel design.

In the display area DA, each of the signal lines S1 to Sm extends in the fifth direction D5. That is, the extending direction of each of the signal lines S1 to Sm is a direction which forms a second angle θ2 with respect to the reference line RF. In other words, each of the signal lines S1 to Sm extends from the first end portion 11A toward the fourth end portion 12B. Note that the expression “extending from the first end portion 11A toward the fourth end portion 12B” is not necessarily limited to the case where each of the signal lines S1 to Sm extends in a direction parallel to the straight line connecting the first end portion 11A and the fourth end portion 12B. In one example, the signal lines S1 to Sm may be parallel to one another in the display area DA.

Each of the signal lines S1 to Sm is drawn out from the display area DA to the non-display area NDA and then connected to the source driver SD. For example, some of the signal lines S1 to Sm, including the outermost signal line S1, are drawn out to the first area A1, then pass through the first area A1 and the third area A3, and are connected to the source driver SD. In this case, the outermost signal line S1 has a portion extending in the fifth direction D5, a portion extending in the second direction Y, and a portion extending toward the source driver SD in the non-display area NDA, but the configuration is not limited to that of this example. For example, the outermost signal line S1 may be constituted solely by the portion extending in the fifth direction D5 without having the portion extending in the second direction Y. Of the signal lines S1 to Sm, the other signal lines including the signal line Sm are not drawn out to the first area A1 but are drawn out to the third area A3 and connected to the source driver SD. With this configuration, compared to the case where all signal lines S1 to Sm are drawn out to the first area A1, the area of the first area A1 can be reduced, making it possible to achieve narrow bezel design.

Note that the connection relationship between the gate driver GD and each scanning line G, and the relationship between the source driver SD and each signal line S are not limited to those of this example.

In the display area DA, when a scanning line G extends in the fourth direction D4, for example, the outermost scanning line G1 has a longer wiring length in the non-display area NDA compared to other scanning lines G, but it has a shorter wiring length in the display area DA. On the other hand, scanning lines G having longer wiring lengths in the display area DA are drawn out to the vicinity of the gate driver GD, and therefore the wiring lengths in the non-display area NDA are shorter. With this configuration, variations in wiring resistance caused by differences in wiring lengths among the scanning lines G1 to Gn can be reduced. Further, compared to such a configuration that the scanning lines G1 to Gn are drawn out on both sides (both the first area A1 and the second area A2) relative to the display area DA, the wiring lengths of the scanning lines G1 to Gn can be shortened, thereby making it possible to reduce the wiring resistance.

Further, when the scanning lines G extend in the fourth direction D4, the scanning lines G are not drawn out to the first area A1 but are drawn out to the second area A2 and the third area A3. Therefore, it is possible to concentrate the gate drivers GD only on the second end portion 11B side of the third area A3. By concentrating the gate drivers GD on one side, the overall size of the gate drivers GD can be reduced.

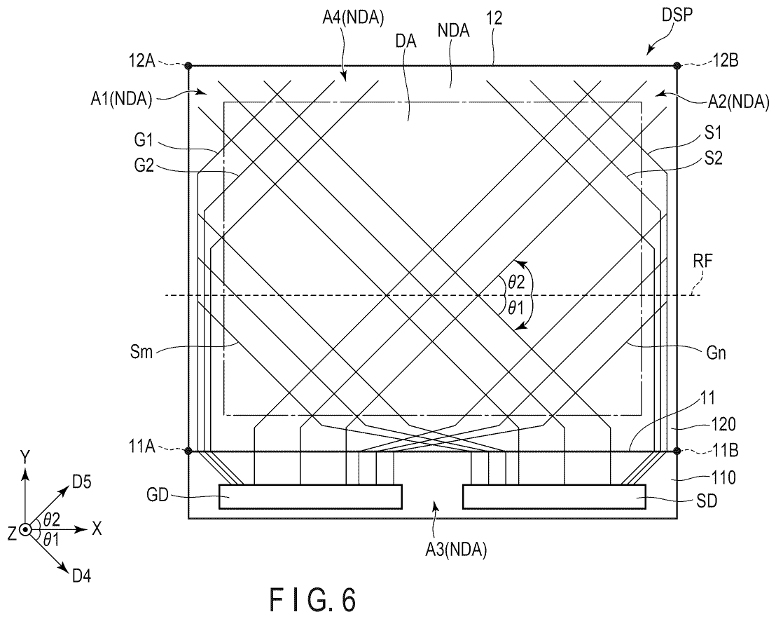

FIG. 6 is a diagram showing another configuration example of the display device DSP.

The configuration example shown in FIG. 6 is different from the configuration example shown in FIG. 5 in the extending directions of the scanning lines G and signal lines S, and the positions of the gate driver GD and source driver SD. Hereinafter, the same reference numerals are used for the same components as those of the configuration example shown in FIG. 5, and explanations therefor may be omitted.

Of the scanning lines G1 to Gn, the outermost scanning line G1 is closest to the first end portion 11A and the third end portion 12A. Of the signal lines S1 to Sm, the outermost signal line S1 is closest to the second end portion 11B and the fourth end portion 12B.

In the display area DA, each of the scanning lines G1 to Gn extends in the fifth direction D5. That is, the extending direction of each of the scanning lines G1 to Gn is a direction that forms a second angle θ2 with respect to the reference line RF. In other words, each of the scanning lines G1 to Gn extends from the first end portion 11A toward the fourth end portion 12B. Note that the expression “extending from the first end portion 11A toward the fourth end portion 12B” is not necessarily limited to such a case where each of the scanning lines G1 to Gn extends in a direction parallel to the straight line connecting the first end portion 11A and the fourth end portion 12B. In one example, the scanning lines G1 to Gn are parallel to each other in the display area DA.

In the display area DA, each of the signal lines S1 to Sm extends in the fourth direction D4. That is, the extending direction of each of the signal lines S1 to Sm is a direction that forms a first angle θ1 with respect to the reference line RF. In other words, each of the signal lines S1 to Sm extends from the second end portion 11B toward the third end portion 12A. Note that the expression “extending from the second end portion 11B toward the third end portion 12A” is not necessarily limited to such a case where each of the signal lines S1 to Sm extends in a direction parallel to the straight line connecting the second end portion 11B and the third end portion 12A. In one example, the signal lines S1 to Sm are parallel to each other in the display area DA.

In the example of FIG. 6, the gate driver GD is arranged on the side of the first end portion 11A of the third area A3. The source driver SD is arranged on the side of the second end portion 11B of the third area A3. Note here that there may be a plurality of gate drivers GD and source drivers SD provided.

Each of the scanning lines G1 to Gn is drawn out from the display area DA to the non-display area NDA and then connected to the gate driver GD. For example, some of the scanning lines G1 to Gn, including the outermost scanning line G1, are drawn out to the first area A1, then pass through the first area A1 and the third area A3, and are connected to the gate driver GD. In this case, the outermost scanning line G1 has a portion extending in the fifth direction D5, a portion extending in the second direction Y, and a portion extending toward the gate driver GD in the non-display area NDA, but note that the configuration is not limited to that of this example. For example, the outermost scanning line G1 may be constituted solely by a portion extending in the fifth direction D5 without having a portion extending in the second direction Y. Of the scanning lines G1 to Gn, the other scanning lines including the scanning line Gn are drawn out to the third area A3 without being drawn out to the first area A1 and are connected to the gate driver GD.

Each of the signal lines S1 to Sm is drawn out from the display area DA to the non-display area NDA and then connected to the source driver SD. For example, some of the signal lines S1 to Sm, including the outermost signal line S1, are drawn out to the second area A2, pass through the second area A2 and the third area A3, and are connected to the source driver SD. In this case, the outermost signal line S1 has a portion extending in the fourth direction D4, a portion extending in the second direction Y, and a portion extending toward the source driver SD in the non-display area NDA, but note that the configuration is not limited to this example. For example, the outermost signal line S1 may be constituted solely by the portion extending in the fourth direction D4 without having the portion extending in the second direction Y. Of the signal lines S1 to Sm, the other signal lines including the signal line Sm are drawn out to the third area A3 without being drawn out to the second area A2, and are connected to the source driver SD.

Note that the connection relationship between the gate driver GD and each scanning line G, and the relationship between the source driver SD and each signal line S are not limited to those of this example.

In the configuration example shown in FIG. 6 as well, advantageous effects similar to those exhibited by the configuration example shown in FIG. 5 can be obtained.

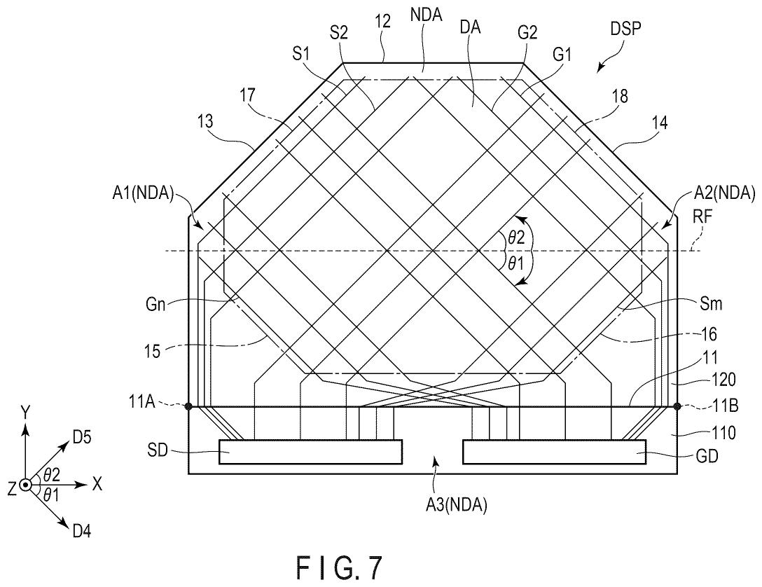

FIG. 7 is a diagram showing another configuration example of the display device DSP.

The configuration example shown in FIG. 7 is a modified example of the display panel PNL and the display area DA. Hereinafter, the same reference numerals are used for the same components as those in the configuration examples shown in FIGS. 5 and 6, and explanations therefor may be omitted.

The display panel PNL, in plan view, has a first edge 11 and a second edge 12 extending in the first direction X, and in addition, a third edge 13 and a fourth edge 14 extending in directions different from the first direction X and the second direction Y. In the example illustrated, the third edge 13 extends in the fifth direction D5, and the fourth edge 14 extends in the fourth direction D4. The extending directions of the third edge 13 and the fourth edge 14 are not limited to those of this example, whereas the extending direction of the third edge 13 should preferably be as close as possible to be parallel to the fifth direction D5, and the extending direction of the fourth edge 14 should preferably be as close as possible to be parallel to the fourth direction D4.

The third edge 13 and the fourth edge 14 face the first edge 11 in the second direction Y. The third edge 13 faces the fourth edge 14 in the first direction X. The display area DA is located between the first edge 11 and the third edge 13, between the first edge 11 and the fourth edge 14, and between the third edge 13 and the fourth edge 14.

The display area DA includes a fifth edge 15, a sixth edge 16, and a seventh edge 17, and an eighth edge 18.

The fifth edge 15 to the eighth edge 18 each extend in directions different from the first direction X and the second direction Y. For example, the fifth edge 15 and the eighth edge 18 extend in the fourth direction D4, and the sixth edge 16 and the seventh edge 17 extend in the fifth direction D5. The extending directions of the fifth edge 15 to the eighth edge 18 are not limited to those of this example, but the extending directions of the fifth edge 15 and the eighth edge 18 should preferably be as close to parallel as possible to the fourth direction D4, and the extending directions of the sixth edge 16 and the seventh edge 17 should preferably be as close to parallel as possible to the fifth direction D5.

In the example of FIG. 7, the display area DA is an octagon including the fifth edge 15 to the eighth edge 18. Note that the shape of the display area DA is not limited to that of this example. For example, it may as well be a polygon other than an octagon, or a rhombus formed by the fifth edge 15 to the eighth edge 18 only. Further, the display area DA does not necessarily need to include all of the fifth edge 15 to the eighth edge 18 in its shape. For example, it may be a hexagon including the seventh edge 17 and the eighth edge 18, or even a circular shape.

The fifth edge 15 is closer to the first end portion 11A than the eighth edge 18, and the sixth edge 16 is closer to the second end portion 11B than the seventh edge 17. Further, the seventh edge 17 is closer to the third edge 13 than the sixth edge 16, and the eighth edge 18 is closer to the fourth edge 14 than the fifth edge 15.

In the example of FIG. 7, the non-display area NDA includes a first area A1 and a second area A2 located on respective sides of the display area DA in the first direction X, and a third area A3 aligned with the display area DA in the second direction Y. That is, the first area A1, the display area DA, and the second area A2 are arranged in this order along the first direction X, and the third area A3 and the display area DA are arranged along the second direction Y. The boundaries of the first area A1 to the third area A3 are not strictly defined and one area may overlap with another area.

In the display area DA, each of the scanning lines G1 to Gn extends in the fourth direction D4. Further, each of the signal lines S1 to Sm extends in the fifth direction D5.

The extending directions of each of the scanning lines G1 to Gn and each of the signal lines S1 to Sm are not limited to those of the example set out above. For example, as shown in the configuration of FIG. 6, each of the scanning lines G1 to Gn may extend in the fifth direction D5, and each of the signal lines S1 to Sm may extend in the fourth direction. Further, the connection relationship between the gate driver GD and each scanning line G, and the relationship between the source driver SD and each signal line S are not limited to those of this example.

The outermost scanning line G1 extends parallel to the eighth edge 18. There are no scanning lines drawn to the non-display area NDA between the fourth edge 14 and the eighth edge 18. With this configuration, the area between the fourth edge 14 and the eighth edge 18 can be reduced, thereby making it possible to achieve narrower bezel design.

The outermost signal line S1 extends parallel to the seventh edge 17. There are no signal lines drawn to the non-display area NDA between the third edge 13 and the seventh edge 17. With this configuration, the area between the third edge 13 and the seventh edge 17 to be reduced, thereby making it possible to achieve narrower bezel design.

In the embodiment described above, for example, the transparent substrate 110 corresponds to the first transparent substrate, the transparent substrate 120 corresponds to the second transparent substrate, and the transparent substrate 140 corresponds to the third transparent substrate. The first area A1 corresponds to the first non-display area, and the second area A2 corresponds to the second non-display area.

As described above, according to the present embodiment, it is possible to provide a display device with improvement display quality.

Based on the display devices described above as embodiments of the invention, a person having ordinary skill in the art may achieve display devices with arbitral design changes; however, as long as they fall within the scope and spirit of the present invention, all of such display devices are encompassed by the scope of the present invention.

A skilled person would conceive various changes and modifications of the present invention within the scope of the technical concept of the invention, and naturally, such changes and modifications are encompassed by the scope of the present invention. For example, if a skilled person adds/deletes/alters a structural element or design to/from/in the above-described embodiments, or adds/deletes/alters a step or a condition to/from/in the above-described embodiment, as long as they fall within the scope and spirit of the present invention, such addition, deletion, and altercation are encompassed by the scope of the present invention.

Furthermore, regarding the present embodiments, any advantage and effect those will be obvious from the description of the specification or arbitrarily conceived by a skilled person are naturally considered achievable by the present invention.

What is claimed is:

1. A display device comprising:
a display panel including a display area which displays images; and
a plurality of light-emitting units each having a light-emitting surface which irradiates light toward the display panel, wherein
the display panel comprises
a first transparent substrate, a second transparent substrate facing the first transparent substrate, a liquid crystal layer containing a polymer-dispersed liquid crystal and located between the first transparent substrate and the second transparent substrate, scanning lines located between the first transparent substrate and the liquid crystal layer, and signal lines located between the first transparent substrate and the liquid crystal layer and intersecting the scanning lines,
the plurality of light-emitting units are arranged along a first edge extending in a first direction of the display panel in plan view, and
each of the scanning lines and signal lines extends in a direction different from the first direction and a second direction perpendicular to the first direction in the display area in plan view.

2. The display device of claim 1, wherein
a normal of the light-emitting surface is parallel to the second direction.

3. The display device of claim 1, wherein
an extending direction of the scanning lines forms a first angle with respect to a reference line parallel to the first direction in the display area,
an extending direction of the signal lines forms a second angle with respect to the reference line,
the first angle is an acute angle clockwise relative to the reference line, and
the second angle is an acute angle counterclockwise relative to the reference line.

4. The display device of claim 3, wherein
each of the first angle and the second angle is 30 degrees or more and 45 degrees or less.

5. The display device of claim 3, wherein
the first angle is equal to the second angle.

6. The display device of claim 1, wherein
the first edge includes a first end portion and a second end portion on an opposite side to the first end portion,
a second edge of the display panel faces the first edge in the second direction, and extends in the first direction,
the display area is located between the first edge and the second edge in the second direction,
the second edge has a third end portion facing the first end portion in the second direction, and a fourth end portion facing the second end portion in the second direction,
the signal lines extend from the first end portion towards the fourth end portion in the display area, and
the scanning lines extend from the second end portion towards the third end portion in the display area.

7. The display device of claim 6, further comprising:
a gate driver to which the scanning lines are connected; and
a source driver to which the signal lines are connected,
wherein
the gate driver is disposed on a side of the second end portion, and
the source driver is disposed on a side of the first end portion.

8. The display device of claim 1, wherein
an extending direction of the signal lines forms a first angle with respect to a reference line parallel to the first direction in the display area,
an extending direction of the scanning lines forms a second angle with respect to the reference line,
the first angle is an acute angle clockwise relative to the reference line, and
the second angle is an acute angle counterclockwise relative to the reference line.

9. The display device of claim 1, wherein
the first edge includes a first end portion and a second end portion on an opposite side to the first end portion,
a second edge of the display panel faces the first edge in the second direction, and extends in the first direction,
the display area is located between the first edge and the second edge in the second direction,
the second edge include a third end portion facing the first end portion in the second direction, and a fourth end portion facing the second end portion in the second direction,
the scanning lines extend from the first end portion toward the fourth end portion in the display area, and
the signal lines extend from the second end portion toward the third end portion in the display area.

10. The display device of claim 9, further comprising:
a gate driver to which the scanning lines are connected; and
a source driver to which the signal lines are connected,
wherein
the gate driver is disposed on a side of the first end portion, and
the source driver is disposed on a side of the second end portion.

11. The display device of claim 8, wherein
each of the first angle and the second angle is 30 degrees or more and 45 degrees or less.

12. The display device of claim 8, wherein
the first angle is equal to the second angle.

13. The display device of claim 1, further comprising:
a third transparent substrate overlaid on the display panel; and
a light guide disposed between the plurality of light-emitting units and the third transparent substrate and facing a side surface of the third transparent substrate.

14. The display device of claim 1, wherein
the display panel further comprises switching elements electrically connected to the scanning lines and the signal lines, and pixel electrodes electrically connected to the switching elements, and
the pixel electrodes are each formed in an area surrounded by respective ones of the signal lines and respective ones of the scanning lines.

15. A display device comprising:
a display panel comprising polymer-dispersed liquid crystal, and a plurality of light-emitting units arranged along a first direction,
wherein
the display panel comprises
a first non-display area, a display area, and a second non-display area arranged in order along the first direction,
a plurality of scanning lines arranged along the first direction in the display area, and
a plurality of signal lines arranged along the first direction in the display area and intersecting the plurality of scanning lines, and
an outermost scanning line of the plurality of scanning lines is located in either one of the first non-display area and the second non-display area, and extends in a direction different from the first direction and a second direction, which is perpendicular to the first direction, in the display area, and
an outermost signal line of the plurality of signal lines is located in an other one of the first non-display area and the second non-display area and extends in a direction different from the first direction and the second direction in the display area.

16. The display device of claim 15, wherein
the plurality of scanning lines are parallel to each other in the display area, and
the plurality of signal lines are parallel to each other in the display area.

17. The display device of claim 15, wherein
each of the plurality of light-emitting units includes a light-emitting surface, and
a normal of the light-emitting surface is parallel to the second direction.

18. The display device of claim 15, wherein
each of the plurality of scanning lines does not include a curved portion between respective adjacent two of the signal lines, and
each of the plurality of signal lines does not include a curved portion between respective adjacent two of the scanning lines.

19. The display device of claim 15, further comprising:
a third transparent substrate overlaid on the display panel; and
a light guide disposed between the plurality of light-emitting units and the third transparent substrate and facing a side surface of the third transparent substrate.

20. The display device of claim 15, wherein
the display panel further comprises switching elements electrically connected to the scanning lines and the signal lines, and pixel electrodes electrically connected to the switching elements, and
the pixel electrodes are each formed in an area surrounded by respective ones of the signal lines and respective ones of the scanning lines.
